(19) United States
(12) Patent Application Publication
(10) Pub. No.: US 2017/0225990 A1
(43) Pub. Date: Aug. 10, 2017

(54) Method of Removing Chromate Ions from an Ion-Exchange Effluent

(71) Applicant: IONEX SG LIMITED, Gloucestershire (GB)

(72) Inventor: Michael Waite, Gloucesershire (GB)

(21) Appl. No.: 15/328,649

(22) PCT Filed: Jul. 24, 2015
(86) PCT No.: PCT/GB2015/052160

§ 371 Date: Jan. 24, 2017

(30) Foreign Application Priority Data
Jul. 25, 2014 (GB) 1413222.9

(51) Int. Cl. C02F 9/00; B01J 41/05; B01J 49/57

(52) U.S. Cl. CPC C02F 9/00; B01J 49/57; B01J 41/05; C02F 2101/22

(57) ABSTRACT

The present invention relates to a method of removing chromate ions from an ion-exchange effluent, the method comprising: (i) providing an ion-exchange effluent comprising chromate ions obtained from the regeneration of an ion-exchange material, (ii) admixing the ion-exchange effluent with a source of alkali metal dithionite to form a first precipitate, and (iii) removing the first precipitate

The present invention relates to a method for the removal of chromate ions from water. In particular, the invention relates to a method for removing chromate ions from an ion-exchange effluent obtained from the regeneration of an ion-exchange material, and to the use of an alkali metal dithionite or alkali metal metabisulfite to remove chromate ions from such an effluent.

Common contaminants in typical drinking water are sulphate, nitrate, bicarbonate and chloride. Chromate ions are also a common contaminant in water in a number of regions and concerns over the health effects of this have led to increasing requirements to reduce levels in potable water.

U.S. Pat. No. 2,864,665 teaches the reduction of plutonium to Pu³⁺ by sodium dithionite in potassium carbonate.

U.S. Pat. No. 5,122,279, U.S. Pat. No. 5,298,168 and U.S. Pat. No. 5,389,262 describe the in situ treatment of metal ion-containing waste waters generated by industries such as metal plating, metal surface finishing or printed circuit manufacturing. These documents teach the reaction of ferrous dithionite with heavy metal ions in acidic water to reduce the heavy metal ions to zero valence. The heavy metal may be chromium.

It is desirable to remove chromate ions from potable water and to treat the resulting chromate-containing waste fraction in such a manner that this fraction may subsequently be disposed of without harmful consequences to the environment. It is also desirable to minimise the volume of the chromium-containing fraction to be treated.

Ion-exchange materials such as strong base anion (SBA) exchange resins and nitrate-selective anion exchange resins are used in systems for the treatment of water, especially but not exclusively, systems for the treatment of drinking water. SBA exchange resins and nitrate-selective anion exchange resins have been used to reduce nitrate levels in water in regions where nitrate levels in water exceed the relevant drinking water standards. Typically, treatment plants operate on a proportion of the total water flow in order to produce a product water which is below the relevant drinking water standard. Traditional treatment methods for chromate ions have used weak base anion resins for their removal or RCF (reduction, coagulation and filtration) with, for example, ferric chloride.

However, depending on the nature of the water to be treated, these methods may also remove a large amount of other anions from the water and produce significant waste volumes with high disposal costs as it is necessary in many instances to treat the entire water flow to reduce chromium levels to acceptable standards. Large volumes of waste effluent require appropriate disposal. The elimination or reduction in volume of chromate ion contaminated waste streams potentially offers advantages in terms of reduction in the cost and/or complexity of equipment required to handle the waste streams and to treat them to achieve environmentally appropriate concentrations for discharge.

Accordingly, it is one object of the present invention to overcome or address the problems of prior art methods for the removal of chromate ions from water and to provide an efficient treatment method, generating a small volume of chromate-containing waste, and treating this waste to allow for its disposal in an environmentally friendly manner.

It is an alternative and/or additional object to provide an efficient method of treating a chromate-containing ion-exchange effluent obtained from the regeneration of an ion-exchange material.

It is an alternative and/or additional object to provide a method of treating water to remove chromate ions and to treat the waste chromate fraction while simultaneously facilitating the removal of other ions, such as nitrate, from the water.

According to a first aspect, the present invention provides a method of removing chromate ions from an ion-exchange effluent, the method comprising:
(i) providing an ion-exchange effluent comprising chromate ions obtained from the regeneration of an ion-exchange material,
(ii) admixing the ion-exchange effluent with a source of alkali metal dithionite to form a first precipitate, and
(iii) removing the first precipitate.

According to a second aspect, the present invention provides a method of removing chromate ions from an ion-exchange effluent, the method comprising:
(i) providing an ion-exchange effluent comprising chromate ions obtained from the regeneration of an ion-exchange material,
(ii) admixing the ion-exchange effluent with a source of alkali metal metabisulfite to form a first precipitate, and
(iii) removing the first precipitate.

According to a third aspect, the present invention provides the use of a source of alkali metal dithionite to remove chromate ions from an ion-exchange effluent obtained from the regeneration of an ion-exchange material.

According to a fourth aspect, the present invention provides the use of a source of alkali metal metabisulfite to remove chromate ions from an ion-exchange effluent obtained from the regeneration of an ion-exchange material.

The present inventors have found that alkali metal dithionite reacts efficiently with chromate ions in an ion-exchange effluent to produce a precipitate which, upon removal from the supernatant liquid, gives a solution having a much-reduced concentration of chromate ions. Without wishing to be bound by theory, it is thought that the chromate ions are reduced to Cr(III) through the addition of the source of alkali metal dithionite, forming a fine precipitate of Cr(OH)₃.6H₂O which can be separated from the regenerant by standard filtration processes.

The present inventors have also found the alkali metal metabisulfite is effective in this regard.

The present disclosure will now be described further. In the following passages different aspects/embodiments of the disclosure are defined in more detail. Each aspect/embodiment so defined may be combined with any other aspect/embodiment or aspects/embodiments unless clearly indicated to the contrary. In particular, any feature indicated as being preferred or advantageous may be combined with any other feature or features indicated as being preferred or advantageous.

The present invention relates to a method for removing chromate ions from an ion-exchange effluent comprising chromate ions. As used herein the term “chromate ions” includes any hexavalent chromium species present in aqueous solution. These include hydrated and non-hydrated forms of CrO₄²⁻, HCrO₄⁻, Cr₂O₇²⁻, HCr₂O₇⁻ and mixtures of two or more thereof. In addition to the chromate ions, the ion-exchange effluent may comprise other metal oxyanions, such as uranyl carbonate, vanadate, arsenate and selenate. Such metal oxyanions are typically present in the ion-exchange effluent in smaller quantities than the chromate ions.

The method comprises providing an ion-exchange effluent comprising chromate ions obtained from the regeneration of an ion-exchange material. An “ion-exchange material” or “ion-exchange resin” is an insoluble matrix (or support structure) normally in the form of small (0.5-1 mm diameter) beads, fabricated from an organic polymer substrate. The beads are typically porous, providing a high surface area. The process of ion-exchange involves passing a solution through a resin, such that the ions present in the solution displace ions that initially form part of the resin. For example, the order of selectivity of a SBA resin is Cl⁻, HCO₃⁻, NO₃⁻ and SO₄²⁻. For nitrate-selective resins, the selectivity of sulphate and nitrate is reversed. Both SBA resins and nitrate-selective resins may be regenerated by elution with, for example, brine (concentrated sodium chloride or potassium chloride solution), as the chloride ions are able to displace HCO₃⁻, SO₄²⁻ and NO₃⁻ ions adsorbed on the resin. The term “ion-exchange material” as used in the context of the present application refers to an ion-exchange material contained within an ion-exchange column. The ion-exchange material may be present in a fixed bed, moving bed or fluidized bed, especially in a fixed bed.

The ion-exchange material may be a strong base anion (SBA) exchange resin. Examples of suitable strong base anion (SBA) exchange resins are Purolite A600E/4149 supplied by Purolite International Limited, Amberlite™ PWA7 supplied by Rohm & Haas Limited, Resintech SGB1 and Resintech SGB2 both supplied by Resintech, Inc., and Lewatit ASB 1 supplied by Lanxess Deutschland GmbH.

Alternatively, the ion-exchange material may be a nitrate-selective anion exchange resin. The nitrate-selective anion exchange material exchanges nitrate ions in water preferentially over other anions such as sulphate and phosphate. The anion exchange resin may, for example, be a nitrate-selective resin which exchanges nitrate ions with chloride or bicarbonate ions. Examples of suitable nitrate selective resins are Purolite A520E supplied by Purolite International Limited and Amberlite PWA5, supplied by The Dow Chemical Company.

The term “ion-exchange effluent” as used in the context of the present application means the waste solution obtained from an ion-exchange column outlet upon elution of the ion-exchange material with a regenerant. Preferably the ion-exchange effluent comprises sodium chloride or potassium chloride, more preferably wherein the ion-exchange effluent comprises from 0.3 to 15% w/v of sodium chloride or potassium chloride and most preferably from 1.5 to 15% w/v, and most preferably from 2 to 5% w/v. As explained above, chloride ions are able to displace ions adsorbed onto an ion-exchange resin, thus regenerating the resin and providing an effluent containing ions that were previously adsorbed onto the resin.

A subsequent step of the present method involves admixing the ion-exchange effluent with a source of alkali metal dithionite to form a first precipitate. Lithium, sodium, potassium, rubidium and caesium are all alkali metals. Preferably the alkali metal comprises sodium dithionite and/or potassium dithionite. More preferably, the alkali metal dithionite consists of sodium dithionite. As will be explained below, the use of sodium dithionite facilitates the greatest enhancement in filterability characteristics of the resulting precipitate.

The dithionite ion [S₂O₄]²⁻, also known as hydrosulfite, is an oxoanion of sulfur formally derived from dithionous acid, H₂S₂O₄. The source of alkali metal dithionite acts as a precipitant in the present process, that is to say, it is the addition of alkali metal dithionite that causes the formation of the precipitate.

The step of admixing the ion-exchange effluent with a source of alkali metal dithionite generally involves delivering the ion-exchange effluent to a collection tank fitted with a low shear mechanical stirrer. The source of alkali metal dithionite is added to the collection tank containing the chromate waste and mixed to allow the precipitate to develop. Preferably, the mixing is carried out for from 2 to 60 minutes, more preferably for from 10 to 30 minutes.

The source of alkali metal dithionite may be the alkali metal dithionite itself. Thus, alkali metal dithionite powder may be added to the ion-exchange effluent. Alternatively or in addition, the source of alkali metal dithionite may be an aqueous solution of alkali metal dithionite, or a plurality of precursor materials which, upon mixing within the ion-exchange effluent, form alkali metal dithionite in situ. For example, sodium dithionite can be made in situ by adding sodium bisulphite and passing the liquid over zinc metal. Where the alkali metal dithionite is sodium dithionite, it may be added in either powder or liquid form. Preferably, the sodium dithionite is added in powder form. The sodium dithionite can be manufactured electrochemically as a liquid, but the dry powder form is advantageous as it is commonly available and is more stable than the liquid form.

The step of admixing the ion-exchange effluent with the source of alkali metal dithionite is preferably carried out at ambient temperature (25° C.).

A further step of the present method involves removing the above-described first precipitate. The precipitate may be removed by means of filtration. Generally, this involves pumping the suspension using a low shear pump capable of pumping liquids containing suspended solids through, for example, a filter press or similar filtration device to remove the precipitate. Alternatively, the suspension can be treated by using a centrifuge to separate the precipitate from the liquid.

The present inventors have found that by adding a source of alkali metal dithionite to an ion-exchange effluent obtained from the regeneration of an ion-exchange material, it is possible to form a first precipitate that is easy to separate from the supernatant liquid by means of conventional methods such as filtration. Without wishing to be bound by theory, it is thought that the reaction separates the Cr(VI) from naturally occurring complexing agents e.g. fulvic acid, present in groundwater and reduces the hazardous Cr(VI) to benign Cr(III), forming a precipitate of Cr(OH)₃.6H₂O. It has been found that the use of alkali metal dithionite in the present process, as opposed to ferrous dithionite, allows the efficient removal of chromate ions without the generation of excessive quantities of precipitate to be removed, since the sodium ions remain in solution whereas iron precipitates from the solution. The present inventors have found, advantageously, that where alkali metal dithionite is used, any residual dithionite naturally breaks down and the products are non-hazardous. In particular, it has been found that the filterability characteristics of the precipitate, and the extent to which residual dithionite breaks down, are most improved through the use of sodium dithionite.

As will be demonstrated in the Examples below, a large proportion of the chromate ions, and even substantially all of the chromate ions present in the regenerant, can be removed by the present method. As will be appreciated, the precise proportion of chromate ions that are removed will depend on factors such as the amount of alkali metal dithionite added relative to the initial chromate concentration. This is demonstrated in the Examples below. Furthermore, it may be desirable to achieve different levels of chromate removal in different applications, depending on the particular environmental standards that must be met. Preferably at least 60 wt % of the chromate ions are removed from the ion-exchange effluent based on the total amount of chromate ions initially present in the ion-exchange effluent, more preferably at least 75 wt %, still more preferably at least 90 wt %, and preferably at most 99.5 wt %.

Many techniques are known in the art for the determination of total chromium in a sample, including Inductively Coupled Plasma Mass Spectrometry (ICPMS), absorption spectroscopy, emission spectroscopy, X-ray fluorescence, and neutron activation analysis. For determining chelated chromium or the hexavalent or trivalent form only, such methods as gas chromatography (with various detection techniques), liquid chromatography (LC), polarography, and spectrophotometry can be used. Preferably, hexavalent chromium is determined by LC-ICPMS. Alternatively, Environmental Protection Agency method number 218.6 may be used (“Determination of Dissolved Hexavalent Chromium in Drinking Water, Groundwater and Industrial Wastewater Effluents by Ion Chromatography”).

As will be appreciated, it may be possible for a small amount of precipitate to remain dispersed in the supernatant liquid, depending on the quality of the separation apparatus used. In such cases, it remains possible for the supernatant to be disposed of without further treatment, provided that the chromium levels have been reduced to the appropriate environmental standards. It should be noted, however, that it is preferred that all of the precipitate is removed. This is because any benign Cr(III) that remains in the supernatant liquid may convert back to toxic Cr(VI) in water and in the human body, depending on environmental conditions.

The filtered precipitate (filter cake if a filter press is used) can be disposed to landfill, unless the presence of other metals in the precipitate, such as uranium, demand specific treatment. In the case of uranium, this can be separated from the chromate prior to the dithionite addition, by the addition of acid to pH<5, which reduces the uranium present as uranyl carbonate to uranium dioxide, and then disposed of separately or recovered for re-use. Alternatively, the uranium can be co-precipitated with the chromate by the sodium dithionite addition and the precipitate treated by, for example, cementation, for safe disposal at a licensed facility if necessitated by the level of uranium present in the precipitate.

Preferably, prior to the step of admixing the ion-exchange effluent with a source of alkali metal dithionite to form a first precipitate, the ion-exchange effluent is admixed with a source of calcium chloride to form a second precipitate. Without wishing to be bound by theory, it is thought that the second precipitate is a calcium sulfate precipitate. In this embodiment, the ion-exchange effluent comprises sulfate ions, preferably in an amount of up to 100,000 mg/L, more preferably from 20,000 to 70,000 mg/L, still more preferably from 30,000 to 50,000 mg/L, and most preferably about 40,000 mg/L. Preferably at least 60 wt % of the sulfate ions are removed from the ion-exchange effluent based on the total amount of sulfate ions initially present in the ion-exchange effluent, more preferably at least 75 wt %, still more preferably at least 90 wt %, and preferably at most 99.5 wt %. Advantageously, the removal of a significant proportion of the sulfate ions prior to the addition of the source of alkali metal dithionite improves the subsequent reduction of metal oxyanions which have chemical properties similar to sulfates, such as selenate.

The calcium chloride may be added in a molar ratio of from 0.6:1 to 1:1, preferably from 0.8:1 to 1:1, more preferably from 0.9:1 to 1:1, and most preferably from 0.95:1 to 0.98:1, relative to the molar amount of sulfate ions present in the ion-exchange effluent. The calcium chloride may be added as a solid. Alternatively or in addition, it may be added in the form of spent brine from the regeneration of a cation-exchange resin. Typically such a cation-exchange resin may be used on-site for chemical makeup.

In this embodiment, the above-described step of removing the first precipitate further comprises removing the second precipitate. That is to say, the first and second precipitates are removed concurrently as a combined precipitate. Typically, the second precipitate forms the bulk (i.e. over 50% by weight) of the combined precipitate. The combined precipitate can simply be heated in an oven, for example to a temperature of 150° C., producing Plaster of Paris, to enable the combined precipitate to simply be disposed of as a solid waste form by adding the heat-treated precipitate to an appropriate waste disposal vessel and simply adding water and allowing to set.

Preferably the pH of the ion-exchange effluent is at least 5, more preferably at least 6, and most preferably at least 7. Cr(III) is largely insoluble where the pH is at least 5, thus promoting the formation of the precipitate.

Preferably the pH of the ion-exchange effluent is adjusted to from 7 to 10, more preferably from 9 to 10, still more preferably to from 9.2 to 9.4, prior to the step of admixing the ion-exchange effluent with the source of alkali metal dithionite. This has the effect of improving the filtration characteristics of the precipitate. While it is known that such a pH adjustment often improves the filterability of fine, iron-based precipitates in groundwater treatment applications, it is not known to apply to chromium-based precipitates, let alone in ion-exchange effluents. It has also been found that this pH adjustment

The pH of the ion-exchange effluent may be adjusted through the addition of acids and bases that are well known to those skilled in the art. For example, the pH of the effluent may be decreased through the addition of hydrochloric acid, sulphuric acid and the like. The pH of the effluent may be increased through the addition of, for example, sodium hydroxide or potassium hydroxide. As will be appreciated, the concentration and volume of the added acid/base will depend on the initial pH of the ion-exchange effluent and its desired final pH. pH measurement techniques, such as the use of a pH meter or probe, are well known to those skilled in the art. The pH of the ion-exchange effluent is preferably measured at ambient temperature (25° C.) and pressure (1 atmosphere).

Preferably the ion-exchange effluent has a concentration of chromate ions of from 100 to 1000 mg/L, preferably from 200 to 800 mg/L, more preferably from 300 to 600 mg/L. As will be appreciated, the concentration of chromate ions will depend on the method and conditions under which the ion-exchange material has been regenerated, including the salt concentration of the regenerant and the loading of the resin.

Preferably the alkali metal dithionite is added in a mass ratio of from 10:1 to 40:1, preferably from 20:1 to 30:1, more preferably about 25:1, relative to the mass of chromate ions initially present in the ion-exchange effluent. As will be demonstrated in the Examples below, it is possible to achieve an extremely high reduction in chromate levels through the use of at least a ten-fold excess of alkali metal dithionite. Again, a suitable ratio of alkali metal dithionite to chromate ions will depend on the levels of chromate and other ions in the effluent, the desired extent of chromate removal and such like.

As explained above, it is desirable to minimise the volume of the chromium-containing fraction to be treated in order to enhance the efficiency of the process. In particular, it is desirable to provide an effluent that contains chromate to the exclusion of other anions (thus reducing the volume to be treated), while still allowing for the removal of other anions from potable water. Preferably the ion-exchange material is loaded with chromate ions and nitrate ions and is regenerated by the following steps:
(i) passing a first salt solution through the ion-exchange material to form a first effluent solution;
(ii) passing a second salt solution through the ion-exchange material to at least partially remove the chromate ions from the ion-exchange material forming a second effluent solution which is the ion-exchange effluent, wherein the second salt solution has a higher salt concentration than the first salt solution;
(iii) passing a third salt solution through the ion-exchange material to at least partially remove nitrate ions from the ion-exchange material forming a third effluent solution, wherein the third salt solution has a salt concentration higher than the second salt solution.

These process steps provide an efficient way to operate an ion-exchange plant to remove nitrates to the required standards whilst treating the entire flow for chromium removal. The use of a sequential regeneration treatment process allows the regenerant fraction containing the chromium to be separated. Advantageously, the process allows the majority of the chromium ions to be separated as a separate fraction from the majority of the nitrate ions originally present on the column.

Moreover, this process allows for the removal of substantially all of the chromate ions from the ion-exchange material loaded in a relatively small volume of solution. This has the advantage that the amount of waste effluent required to be treated containing high levels of chromate ions is reduced. It is unexpected that such a process is successful as the interaction of chromate ions with the ion-exchange column is thought to be different from the typical ion-exchange interaction of the column with other anions, for example nitrate ions, sulphate ions and/or bicarbonate ions. Conventional ion-exchange loading anions follow an anion exchange series Cl⁻ [symbol] CO₃²⁻ [symbol] NO₃- [symbol] SO₄²⁻. On a nitrate-selective ion-exchange material the series is Cl⁻ [symbol] CO₃²⁻ [symbol] SO₄²⁻ [symbol] NO₃⁻. In order to regenerate the exchange material, the process must be reversed. As chromate ions are known to be retained after the nitrate retention of the column is exhausted, it would be expected, if a typical ion-exchange process is occurring, to be very difficult to regenerate the exchange material once chromate ions are retained on the material. The present inventors have, however, surprisingly found that this is not the case and have found that chromate ions can be removed more easily and substantially before the nitrate ions. Without wishing to be bound by any particular theory, it is thought that the chromate ions may be physically absorbed onto the ion-exchange material. Thus, it has been found that this sequential regeneration process allows the provision of a relatively low volume of chromate-containing effluent for treatment. As such, this combination of features allows for both the efficient removal of chromate from potable water and the subsequent treatment of the chromate-containing waste fraction.

In step (i), a first salt solution is passed through an ion-exchange material containing an ion-exchange material loaded with chromate ions and nitrate ions forming a first effluent solution. Preferably, the first effluent solution comprises sulphate anions and/or bicarbonate anions which have been removed from the ion-exchange material.

Preferably, the first solution is chosen such that elution of an ion-exchange material loaded with chromate ions, nitrate ions and preferably sulphate anions and/or bicarbonate anions results in removal of at least some of the sulphate anions and/or bicarbonate anions from the column into the first effluent solution. Preferably, the first effluent solution is enriched with sulphate anions and/or bicarbonate anions compared with the first salt solution. Preferably at least 75% by weight of the total sulphate anions and/or bicarbonate anions originally present in the ion-exchange material before the regeneration treatment is started are eluted into the first effluent solution. More preferably, at least 90%, or at least 95% by weight of the total sulphate anions and/or bicarbonate anions originally present in the ion-exchange material before the regeneration treatment is started are eluted into the first effluent solution.

As used herein the term “before the regeneration treatment is started” refers to before any of the treatment steps (i) to (iii) have been carried out on the loaded column.

In step (ii), a second salt solution is passed through the ion-exchange material. This second salt solution is passed through the ion-exchange material sequentially after the first salt solution. The second salt solution has a higher salt concentration than the first salt solution. Passing the second salt solution through an ion-exchange material forms a second effluent solution. The second effluent solution comprises chromate ions which have been removed from the ion-exchange material. The second effluent solution is the ion-exchange effluent which is treated to remove chromate ions therefrom.

The second effluent solution is enriched with chromate ions compared with the second salt solution. Preferably at least 75% by weight of the total chromate ions originally present in the ion-exchange material before the regeneration treatment are eluted into the second effluent solution. More preferably, at least 90%, or at least 95% by weight of the total chromate ions originally present in the ion-exchange material before the regeneration treatment is started are eluted into the second effluent solution. Although some of the nitrate ions may be removed in the second effluent solution along with the chromate ions, preferably less than 20%, less than 10% or less than 5% by weight of the total nitrate ions originally present in the ion-exchange material before the regeneration treatment is started are eluted into the second effluent solution. By isolating as as much chromate as possible in the second effluent solution, the volume of the chromate containing-fraction to be treated is reduced. This enhances the overall efficiency of the process, which enables the removal of chromate ions from potable water to form a chromate-containing waste fraction and the efficient treatment of this fraction to remove chromate ions therefrom.

In step (iii), a third salt solution is passed through the ion-exchange material. This third salt solution is passed through the ion-exchange material sequentially after the second salt solution. The third salt solution has a higher salt concentration than the second salt solution. Passing the third salt solution through an ion-exchange material forms a third effluent solution. The third effluent solution comprises nitrate ions which have been removed from the ion-exchange material.

The third effluent solution is enriched with nitrate anions compared with the third salt solution. Preferably at least 75% by weight of the total nitrate anions originally present in the ion-exchange material before the regeneration treatment is started are eluted into the third effluent solution. More preferably, at least 90%, or at least 95% by weight of the total nitrate anions originally present in the ion-exchange material before the regeneration treatment is started are eluted into the second effluent solution.

Preferably the salt solution used to regenerate the resin preferably comprises sodium chloride or potassium chloride. As explained above, chloride ions are able to displace other ions adsorbed on the resin. In this embodiment, the second and/or third salt solution is preferably a more concentrated solution of the same salt as the first solution.

In particular, the first salt solution preferably comprises from 0.2 to 2.0% w/v of sodium chloride or potassium chloride, more preferably from 0.75 to 1.08% w/v. Preferably, in order to remove sulphate anions and/or bicarbonate ions from the loaded material, but preferably not the nitrate anions and/or chromate ions, the concentration of chloride ions in the first salt solution is less than 10,000, preferably less than 8,000 ppm, more preferably less than 6,000 ppm, or less than 4,000 ppm. The preferred concentration of chloride ions may differ depending on the nature of the ion-exchange material. For example, where the ion-exchange material is a SBA resin, the concentration of chloride ions is preferably from 6,000 to 8,000 ppm. Where the ion-exchange material is a nitrate-selective resin, the concentration of chloride ions is preferably from 3,000 to 4,000 ppm.

Preferably the second salt solution comprises from 2 to 12% w/v of sodium chloride or potassium chloride, more preferably from 2.5 to 5.0 w/v. Preferably, in order to remove chromate ions from the loaded material, the concentration of chloride ions in the second salt solution is from 4,000 ppm to 55,000 ppm. Preferably, the concentration of chloride ions in the second salt solution is from 10,000 ppm to 50,000 ppm. It is thought that above 10,000 ppm of chloride ions, the nitrate ions start to be removed from the column. Restricting the resulting second effluent solution to chromate ions affords more efficient treatment for chromate removal. Preferably the third salt solution comprises from 10 to 20% w/v of sodium chloride or potassium chloride. More preferably, it comprises from 12 to 15% w/v solution of sodium chloride or potassium chloride. Preferably, in order to remove nitrate ions from the loaded material, the concentration of chloride ions in the third salt solution is greater than 25,500 ppm, greater than 30,000 ppm, or greater than 60,000 ppm, and for example up to 75,000 ppm.

In a preferred embodiment, the salt concentration of the second salt solution passed through the ion-exchange material is at least two times the salt concentration of the first salt solution passed through the ion-exchange material. Preferably the concentration of the third salt solution passed through the ion-exchange material is at least two times the salt concentration of the second salt solution passed through the ion-exchange material.

Preferably the first salt solution passed through the ion-exchange material preferably has a conductivity of from about 8 to about 20 mScm⁻¹ (milliSiemens cm⁻¹), more preferably of from about 10 to about 15 mScm⁻¹, still more preferably still about 12 mScm⁻¹.

Preferably the second salt solution passed through the ion-exchange material has a conductivity of from about 13 to about 150 mScm⁻¹, preferably from about 25 to about 60 mScm⁻¹, more preferably still about 30 mScm⁻¹.

Preferably the third salt solution passed through the ion-exchange material preferably has a conductivity of greater than 60 mScm⁻¹, more preferably from about 100 to about 160 mScm⁻¹.

The conductivity of a solution may be measured using a standard conductivity probe with K factor of 10. Such a probe will typically measure conductivity from 1 mScm⁻¹ to about 230 mScm⁻¹. Preferably the measurements are taken at 25° C. or temperature compensation is applied to the measurement.

Preferably the ratio of the volume of first salt solution introduced into the column to the volume of second salt solution introduced into the column is from 5:1 to from 3:1.

Preferably the ratio of the volume of second salt solution introduced into the column to the volume of third salt solution introduced into the column is preferably from 1:1 to from 1:5.

When the ion-exchange effluent is obtained as a second effluent solution as described as described above, the method preferably further comprises a step of passing water through the column forming an effluent wash water. More preferably the effluent wash water is recycled and reused in the regeneration method. The wash water is advantageously softened water. It may instead be raw water, for example, ground water, with or without further treatment, such as ground water that has been treated for removal of nitrate ions. A combination of softened water and raw water may be used, applied in a mixture or sequentially. The relative proportions of softened to raw water used can be varied to suit the incident levels of hardness cations and of other ions, for example, sulfate in the raw water. Advantageously, the wash water is recycled for use as the, or for the manufacture of the, first dilute solution. Advantageously, the water wash step is carried out in two phases, comprising a first phase in which a minor proportion of the wash water to be used is passed through the column and a second phase in which a major proportion of the wash water to be used is passed down the column. This enables a chloride ion spike conventionally observed when a freshly generated column is returned to service to be reduced or substantially eliminated.

As explained above, it is the second effluent solution that is to be treated with a source of alkali metal dithionite to remove chromate ions therefrom. However, it is also possible to treat the first and/or third effluent solutions obtained in this embodiment, thus providing an efficient, integrated process for the removal of anions from potable water and for the treatment and disposal of waste fractions obtained therefrom. Therefore, when the ion-exchange effluent is obtained as a second effluent solution as described above, the method preferably further comprises collecting and/or further treating the first effluent and/or the third effluent. Preferably the third effluent solution containing the nitrate anions is subjected to anion removal treatment to remove the nitrate anions, more preferably wherein the anion removal treatment comprises an electrolytic treatment method.

Any suitable treatment method may be used for removal of nitrate ions from the effluent. Illustrative of suitable treatment methods are, for example, electrolytic treatment methods or microbiological treatment methods. Preferably, the effluent is treated to remove nitrate ions in an electrocatalytic method. It is preferred for the electrocatalytic treatment to be carried out in an electrocatalytic cell having a cathode surface that is coated with a layer of rhodium metal, which gives good electrical efficiency. One suitable form of electrocatalytic cell and its mode of operation is described in GB 2348209A. A further suitable method of operating such a cell is described in GB 2365023A.

The method preferably further comprises recycling the first effluent through the ion-exchange resin. This is advantageous as waste volume is reduced by recycling it.

According to a second aspect, the present invention provides a method of removing chromate ions from an ion-exchange effluent, the method comprising:
(i) providing an ion-exchange effluent comprising chromate ions obtained from the regeneration of an ion-exchange material,
(ii) admixing the ion-exchange effluent with a source of alkali metal metabisulfite to form a first precipitate, and
(iii) removing the first precipitate.

Preferably the source of alkali metal metabisulfite comprises sodium metabisulfite. More preferably the source of alkali metal metabisulfite consists of sodium metabisulfite. As explained above, alkali metal metabisulfite reacts efficiently with chromate ions in an ion-exchange effluent to produce a precipitate which, upon removal from the supernatant liquid, gives a solution having a much-reduced concentration of chromate ions.

The foregoing aspects may be freely combined with any of the foregoing aspects disclosed herein. In particular, any features associated with the method involving alkali metal dithionite are equally applicable to the method involving alkali metal metabisulfite.

### FIGURES

The present invention will be described in relation to the following non-limiting figures, in which:

FIG. 1 is a graph showing the effect of increasing the amount of added sodium dithionite on the chromate levels in an ion-exchange effluent (without basifying the effluent prior to the addition of dithionite)

FIG. 2 is a graph showing the effect of increasing the amount of added sodium dithionite on the chromate levels in an ion-exchange effluent (with basification of the effluent prior to the addition of dithionite)

FIG. 3 is a graph showing the elution profile for an example in which an ion-exchange effluent comprising chromate ions is obtained.

### EXAMPLES

The present disclosure will now be described in relation to the following non-limiting examples.

### Example 1

An ion-exchange effluent was obtained from the regeneration of an ion-exchange material, the effluent having 156.00 mg/L Cr, 27.08 g/L Cl, 8.56 g/L S and 11.07 mg/L V, as determined by ICPMS. This effluent solution was divided into portions. Sodium dithionite powder was added to each portion to give different final concentrations of sodium dithionite in the effluent solution. Upon addition of sodium dithionite, a precipitate was observed to form. In each case, the precipitate was filtered off to leave the supernatant liquid. The levels of Cr, Cl, S, As, Se, U and V were measured for each supernatant liquid. In some cases, the effluent solution was basified with sodium hydroxide to pH 9.3 prior to the addition of sodium dithionite.

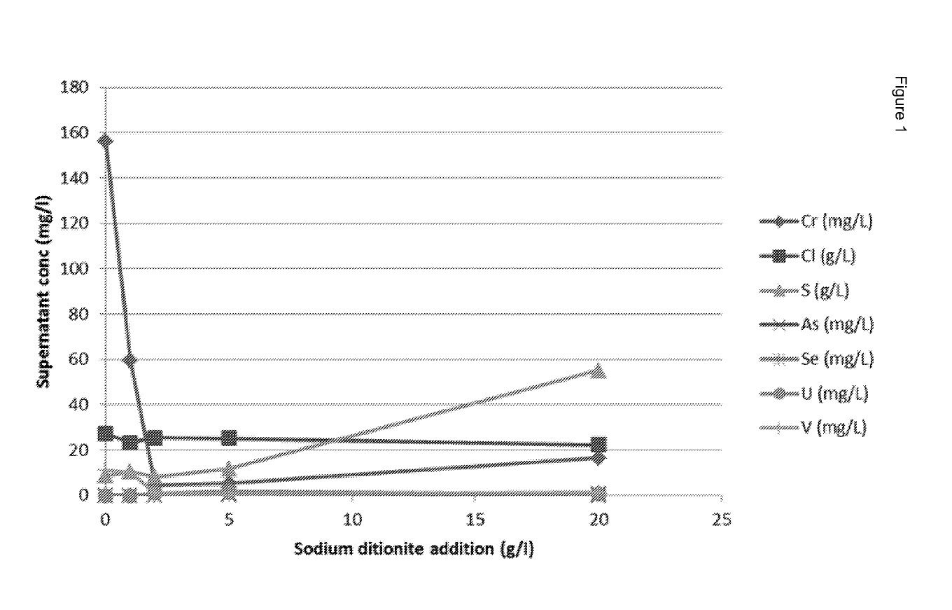

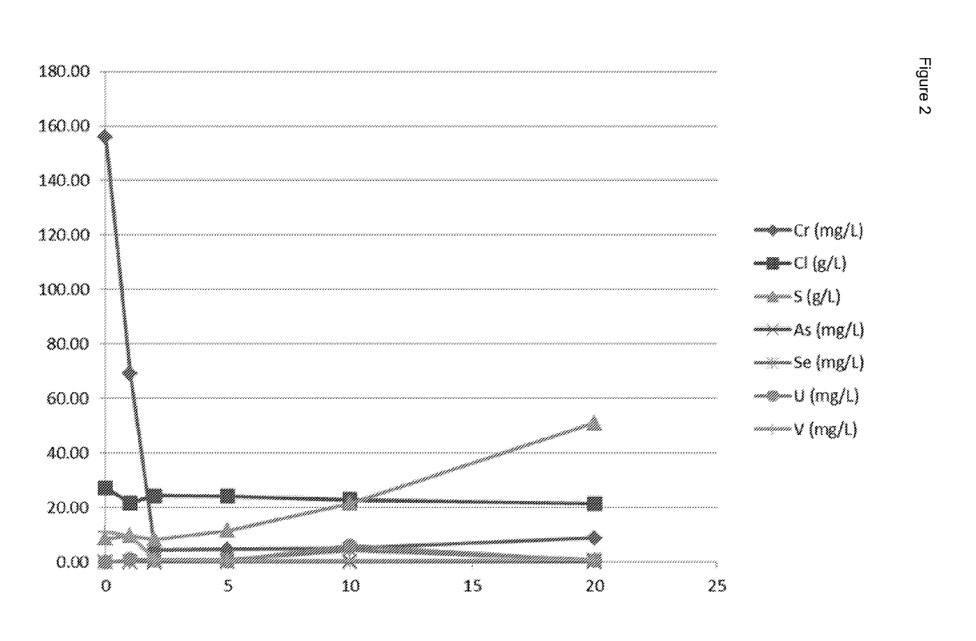

The results are given in the table below and are illustrated in FIGS. 1 and 2.

| | NaOH | | Cr | Cl | S | As | Se | U | V |
|---|---|---|---|---|---|---|---|---|---|
| [Na₂S₂O₄] | added? | Dilutions | (mg/L) | (g/L) | (g/L) | (mg/L) | (mg/L) | (mg/L) | (mg/L) |
| 0 g/L | No | 1484.86 | 156.00 | 27.08 | 8.58 | <MDL | <MDL | <MDL | 11.07 |
| 1 g/L | No | 1069.60 | 59.44 | 23.24 | 10.49 | <MDL | <MDL | <MDL | 10.06 |
| 1 g/L | Yes | 1058.20 | 69.25 | 21.68 | 9.58 | <MDL | <MDL | 0.81 | 9.59 |
| 2 g/L | No | 186.89 | 4.38 | 25.31 | 8.33 | <MDL | <MDL | 0.91 | 0.79 |
| 2 g/L | Yes | 94.09 | 4.38 | 24.37 | 8.38 | 0.10 | 0.93 | 0.76 | 0.76 |
| 5 g/L | No | 95.53 | 5.12 | 25.22 | 11.70 | 0.09 | 0.85 | 1.62 | 0.61 |
| 5 g/L | Yes | 97.23 | 4.67 | 24.14 | 11.57 | 0.07 | 0.91 | 0.42 | 0.56 |
| 10 g/L | Yes | 94.02 | 5.06 | 22.92 | 21.49 | 0.06 | 4.45 | 5.86 | 0.54 |
| 20 g/L | No | 102.53 | 16.55 | 22.32 | 55.06 | <MDL | 0.79 | 0.64 | 1.16 |
| 20 g/L | Yes | 95.18 | 8.87 | 21.43 | 51.07 | <MDL | 0.78 | 0.57 | 0.69 |

(MDL = minimum detection limit)

As can be seen from the table, the addition of sodium dithionite to give a concentration of 1 g/L facilitated around a 60% decrease in Cr levels in the effluent solution. At 2 g/L sodium dithionite and above, the observed decrease was at least 90%. At 5 g/L and 20 g/L sodium dithionite, basification prior to addition of sodium dithionite was found to lower the chromate levels in the resulting supernatant, especially so at 20 g/L. In all experiments, the levels of Cl, As, and Se were found to be relatively constant, indicating that none of these was reduced by the dithionite. By contrast, vanadium levels were found to be significantly lower at 2 g/L sodium dithionite and above, consistent with the reduction of the vanadium ions present in the effluent by the dithionite, leading to precipitation of the vanadium. As expected, sulphur levels were found to increase as the concentration of dithionite increased.

### Example 2

The Purolite A520E (a nitrate-selective ion resin) was loaded with nitrate ions and chromate ions. The following regeneration process was carried out.

A first KCl solution comprising 3000 ppm of chloride ions was prepared. 5 bed volumes of the first solution were passed through the column at flow rate of 5 bed volumes per hour to provide a first effluent comprising sulphate and bicarbonate anions.

A second KCl solution comprising 15000 ppm of chloride ions was then passed through the column. Half a bed volume of the second solution was passed through the column at a flow rate of 2 bed volume per hour to provide a second effluent comprising chromate ions.

A third KCl solution comprising 72000 ppm of chloride ions was then passed through the column. A total of 2.5 bed volume were passed through the column at a flow rate of 2 bed volumes per hour to provide a third effluent comprising nitrate anions.

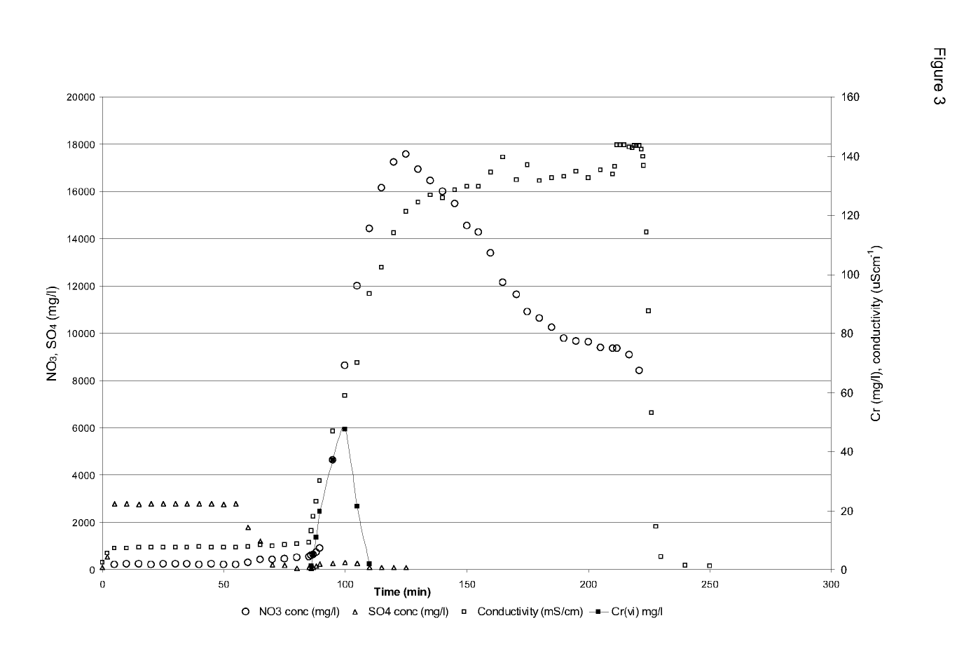

FIG. 3 shows that at time t is 0 to 85 minutes HCO₃⁻ and SO₄²⁻ are removed as a first dilute salt solution is passed through the column. From time t is 85 to 110 minutes, chromate ions (Cr (VI) ions) are removed as the concentration of chloride ions in the salt solution is increased as the second solution is passed through the column. From t is 110 to 220 minutes, nitrate ions NO₃⁻ are removed as the concentration of chloride ions in the salt solution is increased as the third solution is passed through the column. From t 220 to the end shows the results as the column is washed.

This regeneration procedure clearly shows that the chromium can be removed in a small fraction of the waste volume, after the sulphate has been removed and co-incidentally at the beginning of the nitrate removal stage of the process (FIG. 3). In FIG. 3, Cr (mgl⁻¹) and NO₃, SO₄ (mg/l) are plotted on the secondary Y axis. It can clearly be seen that this offers the potential to separate the chromium into a fraction of the regenerant volume which can then be treated in accordance with Example 1.

When introducing elements of the present disclosure or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

The foregoing detailed description has been provided by way of explanation and illustration, and is not intended to limit the scope of the appended claims. Many variations in the presently preferred embodiments illustrated herein will be apparent to one of ordinary skill in the art, and remain within the scope of the appended claims and their equivalents.

1. A method of removing chromate ions from an ion-exchange effluent, the method comprising:
(i) providing an ion-exchange effluent comprising chromate ions obtained from the regeneration of an ion-exchange material,
(ii) admixing the ion-exchange effluent with a source of alkali metal dithionite to form a first precipitate, and
(iii) removing the first precipitate.

2. The method according to claim 1, wherein the method comprises regenerating the ion-exchange material.

3. The method according to claim 1, wherein prior to step (ii), the ion-exchange effluent is admixed with a source of calcium chloride to form a second precipitate, and wherein step (iii) further comprises removing the second precipitate.

4. The method according to claim 1, wherein the ion-exchange effluent comprises sodium chloride or potassium chloride, preferably wherein the ion-exchange effluent comprises from 0.3 to 15% w/v of sodium chloride or potassium chloride, preferably from 1.5 to 15% w/v, and more preferably from 2 to 5% w/v.

5. The method according to claim 1, wherein the first and/or second precipitate is removed by filtration.

6. The method according to claim 1, wherein the pH of the ion-exchange effluent is at least 5, more preferably at least 6, most preferably at least 7.

7. The method according to 6, wherein the pH of the ion-exchange effluent is adjusted to from 9 to 10, preferably to from 9.2 to 9.4, prior to the step of admixing the ion-exchange effluent with the source of alkali metal dithionite.

8. The method according to claim 1, wherein the ion-exchange effluent has a concentration of chromate ions of from 100 to 1000 mg/L, preferably of from 200 to 800 mg/L, more preferably from 300 to 600 mg/L.

9. The method according to claim 1, wherein the alkali metal dithionite is added in a mass ratio of from 10:1 to 40:1, preferably from 20:1 to 30:1, more preferably about 25:1, relative to the mass of chromate ions initially present in the ion-exchange effluent.

10. The method according to claim 1, wherein the source of alkali metal dithionite comprises sodium dithionite, preferably wherein the source of alkali metal dithionite consists of sodium dithionite.

11. The method according to claim 1, wherein at least 60 wt % of the chromate ions are removed from the ion-exchange effluent based on the total amount of chromate ions initially present in the ion-exchange effluent, more preferably at least 75 wt %, still more preferably at least 90 wt %, and preferably at most 99 wt %.

12. The method according to claim 1, wherein the ion-exchange material is a strong base anion (SBA) exchange resin, or wherein the ion-exchange material is a nitrate-selective anion exchange resin.

13. The method according to any of claim 2, wherein the ion-exchange material is loaded with chromate ions and nitrate ions and is regenerated by the following steps:
(i) passing a first salt solution through the ion-exchange material to form a first effluent solution;
(ii) passing a second salt solution through the ion-exchange material to at least partially remove the chromate ions from the ion-exchange material forming a second effluent solution which is the ion-exchange effluent, wherein the second salt solution has a higher salt concentration than the first salt solution;
(iii) passing a third salt solution through the ion-exchange material to at least partially remove nitrate ions from the ion-exchange material forming a third effluent solution, wherein the third salt solution has a salt concentration higher than the second salt solution.

14. The method according to claim 13, wherein the first effluent solution comprises sulphate anions and/or bicarbonate anions which have been removed from the ion-exchange material.

15. The method according to claim 13, wherein the salt solution comprises sodium chloride or potassium chloride.

16. The method according to claim 13, wherein the second and/or third salt solution is a more concentrated solution of the same salt as the first solution.

17. The method according to claim 13, further comprising collecting and/or further treating the first effluent and/or the third effluent.

18. The method according to claim 13, wherein the third effluent solution containing the nitrate anions is subjected to an anion removal treatment to remove the nitrate anions, preferably wherein the anion removal treatment comprises an electrolytic treatment method.

19. A method of removing chromate ions from an ion-exchange effluent, the method comprising:
(i) providing an ion-exchange effluent comprising chromate ions obtained from the regeneration of an ion-exchange material,
(ii) admixing the ion-exchange effluent with a source of alkali metal metabisulfite, preferably sodium metabisulfite, to form a first precipitate, and
(iii) removing the first precipitate.

20. Use of a source of alkali metal dithionite to remove chromate ions from an ion-exchange effluent obtained from the regeneration of an ion-exchange material.

21. The use according to claim 19, wherein the source of alkali metal dithionite comprises sodium dithionite, preferably wherein the source of alkali metal dithionite consists of sodium dithionite.

22. The use according to claim 19, wherein the ion-exchange material is a strong base anion (SBA) exchange resin, or wherein the ion-exchange material is a nitrate-selective anion exchange resin.
